(19) United States
(12) Patent Application Publication
(10) Pub. No.: US 2014/0006113 A1
(43) Pub. Date: Jan. 2, 2014

(54) ELIGIBILITY ASSISTANCE IN SOCIAL MEDIA OFFER SYSTEM

(71) Applicants: DAVID M. GRIGG, Rock Hill, SC (US); Alicia C. Jones, Fort Mill, SC (US); Laura Corinne Bondesen, Charlotte, NC (US); Susan Smith Thomas, Gastonia, NC (US); Matthew A. Calman, Charlotte, NC (US)

(72) Inventors: DAVID M. GRIGG, Rock Hill, SC (US); Alicia C. Jones, Fort Mill, SC (US); Laura Corinne Bondesen, Charlotte, NC (US); Susan Smith Thomas, Gastonia, NC (US); Matthew A. Calman, Charlotte, NC (US)

(73) Assignee: BANK OF AMERICA CORPORATION, CHARLOTTE, NC (US)

(21) Appl. No.: 13/536,373

(22) Filed: Jun. 28, 2012

(51) Int. Cl. G06Q 30/02

(52) U.S. Cl. 705/14.1

(57) ABSTRACT

Embodiments of the invention relate to systems, methods, and computer program products for providing a social media offer system to users. The system assists users in determining whether the users are eligibly for offers provided through social media. In some situations, the system also facilitates eligibility by assisting the user in qualifying for the offer. The system determines that a primary user shared an offer with a secondary user; determines an identity of the secondary user; and determines whether the secondary user is eligible for the offer based on the identity of the secondary user. If the secondary user is not eligible, the system provides information to the secondary user, such as instructions in how to become eligible.

### BACKGROUND

Social media is becoming an important part of people's lives today. Individuals have social media sites for personal and professional activities. An individual may have numerous social media sites with varied contacts and connections in each site. Some people may not want to share certain information with some connections on a social networking site but would like to share that information with other connections on a different social networking site. These individuals have no way of establishing a hierarchy of sharing across multiple social media sites because the sites rarely interact with one another.

Further, offers or advertisements may be provided to individuals through social media sites but without providing any control of the offers to the users themselves. Individuals are outside the process by which offers are determined and provided to individuals in social media sites. This is a drawback to both merchants, who may be targeting individuals inappropriately based on lack of information, and individuals, who may be receiving inappropriate offers. Individuals in social media sites may be aware that certain members of the individual's network or certain groups in the individual's network may desire or be open to different types of offer. Without providing some level of control to the users, however, this type of information is not known to the provider of the offer.

Still further, recipients of offers may not be eligible for the offers. For example, an offer may be for second-time shoppers at a specific business. If a recipient of an offer has not shopped at the merchant previously, the recipient would be ineligible for the offer and may not know how to become eligible for the offer. The ineligible recipient may waste time and the merchant may waste a marketing budget providing offers to individuals that are not eligible and do not know how to become eligible.

Thus, there is a need for a system that provides offers to customers through social media sites and allows those offers to be shared, while still ensuring that the recipients of the offers are eligible.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Some embodiments provide a social media offer system for assisting users in becoming eligible for offers, wherein the system includes a memory device, a communication device, and a processing device. The processing device is operatively coupled to the memory device and the communication device and configured to execute computer-readable program code to determine that a primary user shared an offer with a secondary user; determine an identity of the secondary user; and determine whether the secondary user is eligible for the offer based on the identity of the secondary user. When the secondary user is not eligible for the offer, the system provides information to the secondary user, such as instructions on how to qualify for the offer or assistance in qualifying for the offer. The assistance may include enrolling the secondary user in an account.

In some embodiments, the computer-readable program code is further configured to identify a social media site of the secondary user; evaluate whether the secondary user is eligible for the offer based on the social media site; and offer to alter a profile of the secondary user on the social media site when the secondary user is not eligible for the offer, such that altering the profile makes the secondary user eligible for the offer. In an embodiment, the primary user shares the offer with the secondary user based on a group defined by the primary user. In a still further embodiment, the identity of the secondary user is determined based on a cookie associated with the offer, wherein the cookie reports the identity of the secondary user to the system when the secondary user accesses the offer.

In an embodiment, a social media offer computer program product for assisting users in becoming eligible for offers is provided. In an embodiment, the computer program product includes at least one non-transitory computer-readable medium having computer-readable program code portions embodied therein, the computer-readable program code portions comprising: an executable portion configured for determining that a primary user shared an offer with a secondary user; an executable portion configured for determining an identity of the secondary user; and an executable portion configured for determining whether the secondary user is eligible for the offer based on the identity of the secondary user. When the secondary user is not eligible for the offer, an executable portion provides information to the secondary user. In some embodiments, the information includes on how to qualify for the offer, such as enrolling in a financial account. In other embodiments, the information assists the secondary user in qualifying for the offer, such as by offering to modify the user's profile on the social media site to make the user qualify for the offer.

In a still further embodiment, a social media offer method for assisting users in becoming eligible for offers is provided. In an embodiment, the method includes determining, via a computing device processor, that a primary user shared an offer with a secondary user; determining, via a computing device processor, an identity of the secondary user; and determining, via a computing device processor, whether the secondary user is eligible for the offer based on the identity of the secondary user. When the secondary user is not eligible for the offer, method provides information to the secondary user when the secondary user is not eligible for the offer. As discussed, the information may include instructions on how to qualify for the offer or assistance for the secondary user in qualifying for the offer.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram illustrating a process flow for an apparatus for providing a social media offer system, in accordance with some embodiments of the invention;

FIG. 2 is a depiction of an environment in which an apparatus provides a social media offer system, in accordance with some embodiments of the invention;

FIG. 3 is a block diagram illustrating a mobile device, in accordance with an embodiment of the invention;

FIG. 4 is a block diagram of a social media offer system, in accordance with some embodiments of the invention; and

FIGS. 5A and 5B are flow charts of a system for providing a social media offer system, in accordance with some embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Additionally, while embodiments are disclosed as “comprising” elements, it should be understood that the embodiments may also “consist of” elements or “consist essentially of” elements.

Although embodiments of the present invention described herein are generally described as involving a merchant, it will be understood that merchant may involve one or more persons, organizations, businesses, institutions and/or other entities such as financial institutions, services providers, stores, entities, etc. that implement one or more portions of one or more of the embodiments described and/or contemplated herein.

Apparatuses, systems, methods and computer program products are herein disclosed for providing eligibility assistance in a social media offer system. Specific embodiments disclosed herein relate to a social media offer system for providing offers to users, allowing users to specify how offers are received, allowing users to share offers, and/or providing information in how to qualify for offers. The system results in a viral sharing of offers through social networks. The sharing may be personalized by users and/or offer providers such as financial institutions and merchants. Users who are not eligible for specific offers may be instructed in how to become eligible for the offers, increasing the user's contact with the offer provider. While the social media sites or networks are primarily described as web-based and provided through a computing device or mobile device, it should be understood that other types of social networks (e.g., telecom-based, television, video game, etc.) may be included in the invention as described herein.

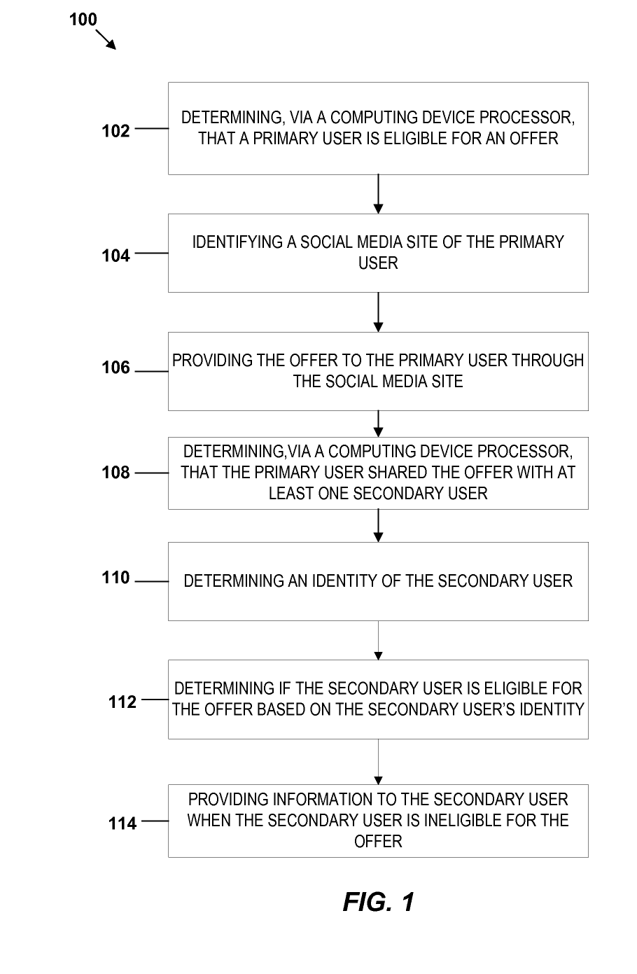

FIG. 1 illustrates a general process flow 100 for an apparatus or system for providing a social media offer system consistent with an embodiment of the present invention. As shown in block 102, the system determines that a primary user is eligible for an offer. In some embodiments, the primary user is a customer of a financial institution, a customer of a merchant, a member of a social media site, or a user that has signed up to receive offers from the financial institution, the merchant, or the social media site. The primary user may opt-in or register to receive offers from the social media offer system. In an embodiment, the primary user has connected a financial account of the user with a social networking account at a social media site. For example, a user's financial account may be linked with a social networking site to earn rewards or points for liking, commenting on, or sharing information from the financial institution.

In some embodiments, the system determines that the primary user is eligible based on an activity of the user. The activity may be a financial activity such as a purchase, a balance transfer, a new account, etc. In another embodiment, the activity is a social media activity, such as liking a post by the financial institution or the merchant on the social media site. In another embodiment, the system determines that the primary user is eligible based on demographics of the user. For example, the user's age or mailing address may be used to provide targeted offers to the user. In a still further embodiment, the user's current information may be used to provide targeted social media offers. For example, the user's current location, the current time, or the current activity (e.g., shopping, etc.) may be used to determine that the user is eligible for an offer. For example, a merchant may decide that all customers that visit the merchant at a specific location during a predetermined time period may be eligible for an offer through social media. In a further embodiment, a user's status on a social media site may be used to determine the user's eligibility for an offer. For example, eligibility may be based on the number of connections in a social media site, the most recent activity on the social media site, or individual metrics calculated by social media sites for individuals. It should be understood that a combination of factors may be used to determine whether a user is eligible for an offer. For example, the system may determine that a user at a specific location taking a specific action on a social media site, such as liking the merchant at that location, is eligible for the offer.

In some embodiments, the user is determined to be eligible based on previous or current sharing activity. For example, the user may be determined to be eligible for the offer because the user shared a similar previous offer with a pre-determined number of individuals, e.g., five individuals, ten individuals, and so forth. In a further embodiment, the user may be determined to be eligible for the offer only after sharing the offer with a pre-determined number of people or in a pre-determined manner. For example, an offer may be posted on a business's social networking site. A user may be able to share or push that offer to other users or into groups. A user that does so a minimum number of times or to a specific type of group (e.g., a group with at least twenty members) may become eligible.

In an embodiment, an offer is a financial offer, such as a discount, sale, rebate, or refund. In another embodiment, the offer is an offer for a social media-related benefit, such as points, status, badges, access, etc. In some embodiments, the offer is personalized for the user. The offer may be personalized based on the user's financial information, social media information, or merchant information. For example, the offer may be personalized for the user based on the user's recent transactions. That is, an offer from a merchant may be identified for the user based on the determination that the user made a purchase at the merchant in the recent past. Similarly, the offer may be an offer based on information in the user's social media site. For example, the user may like or be a fan of a specific product and therefore receive an offer for that product. In another embodiment, the offer is a general offer, for example a general offer that can be used by a limited number of people or an unlimited number of people.

In some embodiments, the type of offer depends on the sharing characteristics of the user. For example, a user may receive better or more lucrative offers based on how many people the user shared to offer with. An offer may be continuously changing based on the user's sharing of the offer. For example, a user may have an offer for X % off a purchase. If the user shares the offer with a predetermined number of people, such as 10 people, the offer may change from X % to Y % off a purchase. Similarly, if the user shares the offer with 10 more people, the offer may change from Y % to Z %. In an embodiment, the user receives credit for offers that are shared by people that have received the offer from that user. For example, if user A shares the offer with user B, and then user B shares the offer with users C and D, in some cases user A may receive credit for the sharing of the offer with users B, C, and D. In some embodiments, secondary sharing (i.e., sharing through an intermediary) is worth less than primary sharing (i.e., direct sharing between two people). In further embodiments, a user's relative influence is determined based on how many secondary users the primary user shares the offer with or on how many secondary users utilize the offer. A user's influence may also be determined based on the value of the offers that are used by the secondary users. Power users may be identified based on the value of the user's sharing ability.

In block 104, the system identifies a social media site of the user. In some embodiments, the system identifies the social media site based on instructions received from the user. In an exemplary embodiment, the user provides a hierarchy of social media sites that determines how offers are provided to the user. For example, the user may establish that business-oriented social media sites receive offers related to financial transactions while personal-oriented social media sites receive offers related to social media (e.g., badges, etc.). In some embodiments, the social media sites are linked to financial accounts of the user so that the system is able to identify the social media sites from a database associated with the financial institution offering the system. In another embodiment, the social media sites are connected to the system using a username and password provided by the user. In a still further embodiment, the social media sites are identified over a publicly accessible network based on the user's name or other user contact information.

In block 106, once the social media site is identified, the system provides the offer to the user through the social media site. The offer may be provided publicly or privately. In an embodiment, the user is able to request public and/or private offers. A private offer may be provided to the user through private message, private instant messaging, SMS message, email, or other type of private contact. In an embodiment, a private offer is an offer that is not viewable by members of the social media site other than the recipient of the offer. A public offer may be made public to a subset of individuals associated with the recipient of the offer, such as a group or circle of friends, acquaintances, or connections. For example, an offer may be posted on a wall or other publicly viewable site on a social media site such that the user can control viewing of the offer by controlling privacy settings related to the publicly viewable site.

As shown in block 108, in some embodiments, the system determines that the user shared the offer with at least one secondary user. In one embodiment, the offer may have a tracking code, cookie, or application that tracks the offer's movement after being provided to the primary user. For example, the offer may send a message to the system when the offer is opened in a new social media site or by a new user (e.g., detecting a new IP address, MAC address, etc.). In a further embodiment, the system determines that the offer has been shared based on the method of sharing. For example, the offer may provide a link or space to share the offer with other members of the social network or with social networks/media sites. Thus, the system itself shares the offer based on instructions received from the user and is able to determine that the user shared the offer with the secondary user in that way.

In an embodiment, once the user is determined to have shared the offer with at least one secondary user, the primary user receives rewards or points for sharing. In this manner, the primary user is provided an incentive to share the offers with others. In an embodiment, the primary user receives points based on the number of people that the user shared the offers with. In some embodiments only primary sharing results in points but in other embodiments users receive points for both primary sharing and secondary sharing. As discussed, in some embodiments secondary sharing is worth fewer points than primary sharing. In some embodiments, a time limit is provided for receiving points based on sharing of offers. In an embodiment, the points are a type of commission. For example, the user may receive rewards or points based on the purchases made by secondary users with whom the primary user shared the offer.

In some embodiments, the user defines a hierarchy for sharing the offer. For example, the user may prioritize friends over acquaintances when publishing offers received from the system. In an embodiment, the primary user is able to share offers and predetermine how different classes of secondary users receive and/or take advantage of offers. For example, close friends of the user may receive better offers (e.g., a greater discount, a higher priority, etc.) than acquaintances of the primary user. In some embodiments, the primary user instructs the system to share the offer through the social media site or sites but does not select individual secondary users to receive the offer. Instead, the system provides the offers to secondary users based on the hierarchy defined by the primary user. For examples, connections of the user may be evaluated and ranked such that the first secondary user to receive an offer is the secondary user with the most connections in common with the primary user. In this manner, social networks are evaluated and those most closely connected receive offers before those that are not as closely socially connected.

In one embodiment, the secondary user is another user of the social media site. For example, the secondary user may be a friend or connection of the primary user. In another embodiment, the secondary user is not a part of the social media site but the offer is shared via some communication method, such as email or text message. The secondary user may be a customer of the financial institution, a member of a social network, or a customer of a merchant. In an embodiment, the secondary user is not known to the primary user. For example, the primary user may share an offer with the closest secondary users of the system when the primary user receives the offer or the primary user may indicate that the next user of the system to enter a general area (e.g., a building of a merchant, etc.) will receive the offer. The secondary user may or may not be eligible for the offer.

Turning now to block 110, in some embodiments the system determines an identity of the secondary user. In an embodiment, the system determines the identity of the user based on the information received when the system determines that the primary user shared the offer. For example, a cookie may transfer both the information that the offer was shared and identifying information for the secondary user to the system. The identifying information may be the secondary user's name, contact information, or IP address. In another embodiment, the secondary user is identified in coordination with account information related to the financial accounts. For example, the email address of the secondary user may be determined and compared to email addresses stored in a financial institution database. In a still further embodiment, the secondary user provides identification information to the system when logging in to access the offer.

In block 112, the system determines if the secondary user is eligible for the offer based on the secondary user's identity. Offers may require specific characteristics in a user. For example, the offer may require that a recipient have shopped at a specific merchant previously or spent a certain amount of money at the merchant previously. The offer may require that the secondary user be a fan of a merchant or financial institution. The offer may require that the secondary user be a customer of a financial institution, have a certain type of account with the financial institution, or maintain a predetermined balance in an account with the financial institution. As should be understood, criteria to determine who is eligible for an offer may be as varied as the offers themselves. The aforementioned examples are not intended to be limiting to the types of criteria, but rather to illustrate examples of criteria associated with offers.

In an embodiment, the system determines if the primary user is abusing the rewards structure, e.g., sending offers to many individuals that are not eligible for the offer or sending offers to email addresses not associated with unique individuals. For example, a user may create many false social networking ID's and attempt to gain rewards by sharing an offer with the false networking ID's. The system may determine that none of the secondary users are eligible for the offer and may also cause a review process to proceed so that the false networking ID's are identified and excluded from further offers.

Finally, in block 114, the system provides information to the secondary user when the secondary user is ineligible for the offer. In an embodiment when the system determines that the secondary user is not eligible for the offer, the system provides instructions to the secondary user in how to become eligible. For example, the system may instruct a user that the user must like or become a fan of a specific merchant on a social media site in order to take advantage of an offer. Similarly, the system may instruct a user that the user must open an account at a financial institution in order to receive the offer. In another embodiment, the system assists the user in qualifying for the offer. For example, the system may provide directions to a business or the amount of money that must be spent at a merchant before qualifying for the offer. In some embodiments, a minimum spend requirement is necessary to receive an offer and the system may determine the amount that the user has already spent at the merchant and the difference between the minimum spend and the current expenditures for the user to assist the user in qualifying for the offer. The system may provide the instructions to the user through a variety of communication means. For example, the secondary user may be contacted via email, through social media sites, or via mail.

It should be understood that the system and method disclosed herein is not limited to a single primary user and a single tier of secondary users. Instead, in some embodiments secondary users may share offers with tertiary users and beyond, thereby creating a viral marketing and sharing system where offers are transmitted from users through social networks. Each secondary user may become a primary user that then shares the offer with the new primary user's social network. In this manner, the offers are spread quickly and have a greater acceptance by recipients because the offers are received from members of the recipients' social circle.

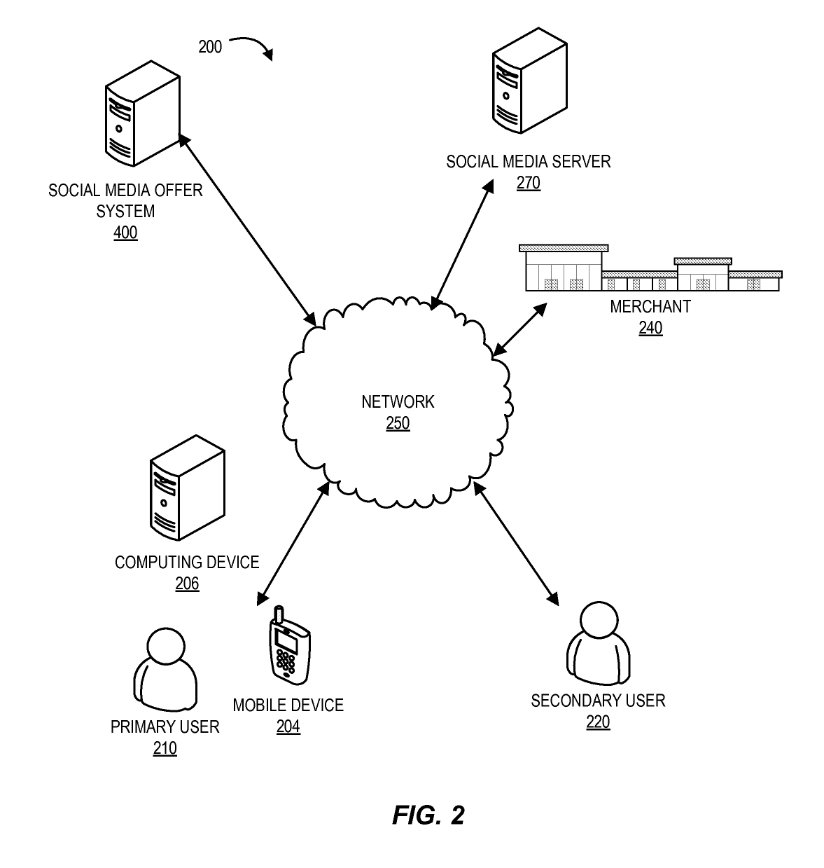

Referring to FIG. 2, a block diagram illustrating an environment 200 in which a social media offer system provides offers to users and allows users to share offers among a social network. The system determines that the user 210 is eligible for an offer, such as an offer from a merchant 240.

In an embodiment, after determining that the user is eligible for the offer, the system identifies a social media site of the user, such as from a social media server 270. The system may identify the social media site based on the primary user's name, contact information (e.g., username, email address, phone number, etc.), or through linkages with the social media offer system. For example, the primary user may link the social media server 270 with the user's financial accounts at the financial institution to receive notices and offers from the financial institution.

In some embodiments, the system provides the offers to the primary user 210 through a mobile device 204 or a computing device 206. For example, the primary user 210 may receive a message from the system through the user's social networking site. In one embodiment, the financial institution or a representative of the financial institution connects with the primary user to provide the offer. For example, a “friend request” or social connection request may be made to the user. In another embodiment, the primary user likes, becomes a fan of, or otherwise indicates an interest in the financial institution, in order to receive an offer.

As shown in FIG. 2, the mobile device and the social media offer system communicate with one another and in some embodiments with secondary users 220 and merchants 240 over a network 250, which may include one or more separate networks. In addition, the network 250 may include a local area network (LAN), a wide area network (WAN), and/or a global area network (GAN), such as the Internet. It will also be understood that the network 250 may be secure and/or unsecure and may also include wireless and/or wireline technology.

In some embodiments, the primary user 210 shares the offer with at least one secondary user 220. The primary user 210 may share the offer over the network 250. In an embodiment, the secondary user 220 receives the offer via a computing device or mobile device. In some embodiments, the secondary user 220 receives the offer via the social network. For example, the secondary user may be connected, e.g., be friends with, be a fan of, etc., the primary user and receive the offer via a public or private message from the primary user. In an embodiment, the social media offer system identifies the secondary user and determines if the secondary user 220 is eligible for the offer. If the secondary user is not eligible, the system may provide instructions to the secondary user in how to become eligible for the offer. It should also be understood that the secondary user 220 may also share the offer with other users, thereby resulting in a viral sharing of offers through social networks.

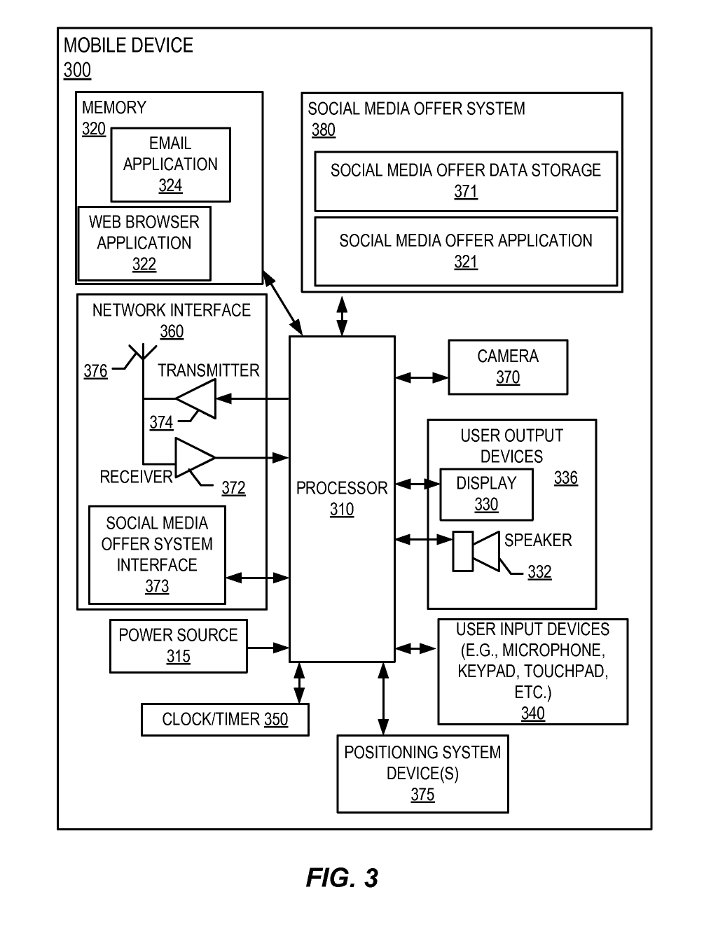

FIG. 3 illustrates an embodiment of a mobile device 300 that may be configured with the social media offer system. A “mobile device” 300 may be any mobile communication device, such as a cellular telecommunications device (i.e., a cell phone or mobile phone), personal digital assistant (PDA), smartphone, a mobile Internet accessing device, or other mobile device including, but not limited to portable digital assistants (PDAs), pagers, mobile televisions, gaming devices, laptop computers, tablet computers, cameras, video recorders, audio/video players, radios, GPS devices, and any combination of the aforementioned, or the like.

The mobile device 300 may generally include a processor 310 communicably coupled to such components as a memory 320, user output devices 336, user input devices 340, a network interface 360, a power source 315, a clock or other timer 350, a camera 370, at least one positioning system device 375, one or more social media offer systems 380, etc. The processor 310, and other processors described herein, may generally include circuitry for implementing communication and/or logic functions of the mobile device 300. For example, the processor 310 may include a digital signal processor device, a microprocessor device, and various analog to digital converters, digital to analog converters, and/or other support circuits. Control and signal processing functions of the mobile device 300 may be allocated between these devices according to their respective capabilities. The processor 310 thus may also include the functionality to encode and interleave messages and data prior to modulation and transmission. The processor 310 may additionally include an internal data modem. Further, the processor 310 may include functionality to operate one or more software programs or applications, which may be stored in the memory 320. For example, the processor 310 may be capable of operating a connectivity program, such as a web browser application 322. The web browser application 322 may then allow the mobile device 300 to transmit and receive web content, such as, for example, location-based content and/or other web page content, according to a Wireless Application Protocol (WAP), Hypertext Transfer Protocol (HTTP), and/or the like.

In some embodiments, the positioning system device 375 is configured to determine the location of the mobile device. For example, at least one of the position system devices 375 may interact with the transceiver to send and/or receive information with wireless transmitters, such as GPS or Wi-Fi. In further embodiments, the positioning system device 375 is configured to determine movement and/or orientation of the mobile device. Accelerometers, magnetometers, and other devices can be included in the mobile device to provide information to the device on the location and velocity (speed and direction) of the device. Other types of positioning system devices 375 may be included in the device without limitation. For example, altimeters can be included in the device to determine the elevation of the device. Similarly, electronic or standard compasses may be included.

The processor 310 may also be capable of operating applications, such as a social media offer application 321. The social media offer application 321 may be downloaded from a server and stored in the memory 320 of the mobile device 300. Alternatively, the social media offer application 321 may be pre-installed and stored in a memory of the social media offer system 380 or activated directly from a website operably linked to the mobile device 300 through the network interface 360. In embodiments where the social media offer application 321 is pre-installed or run from a website, the user may not download the social media offer application 321 from a server.

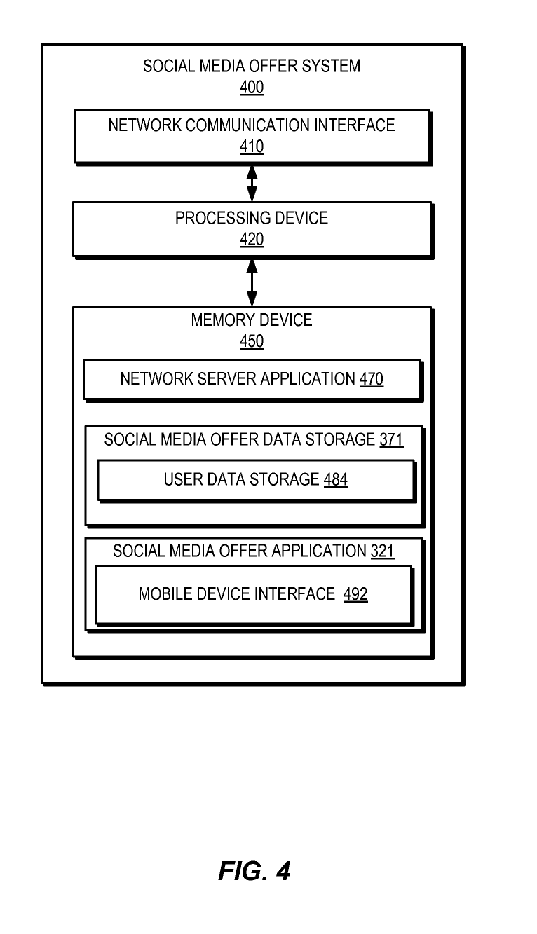

The social media offer system 380, as will be discussed in greater detail in FIG. 4, may include the necessary circuitry to provide the social media offer functionality to the mobile device 300. Generally, the social media offer system 380 will include social media offer data storage 371, i.e., a database, which may include data associated with the offers as well as user data. The social media offer system 380 and/or social media offer data storage 371 may be an integrated circuit, a microprocessor, a system-on-a-chip, a microcontroller, or the like. As discussed above, in one embodiment, the social media offer system 380 provides the social media offer functionality to the mobile device 300.

Of note, while FIG. 3 illustrates the social media offer system 380 as a separate and distinct element associated with the mobile device 300, it will be apparent to those skilled in the art that the social media offer system 380 functionality may be incorporated within other elements in the mobile device 300. For instance, the functionality of the social media offer system 380 may be incorporated within the mobile device memory 320 and/or the processor 310. In a particular embodiment, the functionality of the social media offer system 380 is incorporated in an element within the mobile device 300 that provides social media offer capabilities to the mobile device 300. Moreover, the functionality may be part of the firmware of the mobile device 300. In some embodiments, the functionality is part of an application downloaded and installed on the mobile device 300. Still further, the social media offer system 380 functionality may be included in a removable storage device such as an SD card or the like.

The processor 310 may be configured to use the network interface 360 to communicate with one or more other devices on a network. In this regard, the network interface 360 may include an antenna 376 operatively coupled to a transmitter 374 and a receiver 372 (together a “transceiver”). The processor 310 may be configured to provide signals to and receive signals from the transmitter 374 and receiver 372, respectively. The signals may include signaling information in accordance with the air interface standard of the applicable cellular system of the wireless telephone network that may be part of the network. In this regard, the mobile device 300 may be configured to operate with one or more air interface standards, communication protocols, modulation types, and access types. By way of illustration, the mobile device 300 may be configured to operate in accordance with any of a number of first, second, third, and/or fourth-generation communication protocols and/or the like. For example, the mobile device 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 300 may also be configured to operate in accordance with non-cellular communication mechanisms, such as via a wireless local area network (WLAN) or other communication/data networks.

The network interface 360 may also include a social media offer system interface 373 in order to allow a user to execute some or all of the above-described processes with respect to the social media offer application 321 and/or the social media offer system 380. The social media offer interface 373 may have access to the hardware, e.g., the transceiver, and software previously described with respect to the network interface 360. Furthermore, the social media offer interface 373 may have the ability to connect to and communicate with an external social media offer system 380, such as a system that attaches to or wirelessly communicates with the mobile device 300.

As described above, the mobile device 300 may have a user interface that includes user output devices 336 and/or user input devices 340. The user output devices 336 may include a display 330 (e.g., a liquid crystal display (LCD) or the like) and a speaker 332 or other audio device, which are operatively coupled to the processor 310. The user input devices 340, which may allow the mobile device 300 to receive data from a user 210, may include any of a number of devices allowing the mobile device 300 to receive data from a user 210, such as a keypad, keyboard, touch-screen, touchpad, microphone, mouse, joystick, stylus, other pointer device, button, soft key, and/or other input device(s).

The mobile device 300 may further include a power source 315. Generally, the power source 315 is a device that supplies electrical energy to an electrical load. In one embodiment, power source 315 may convert a form of energy such as solar energy, chemical energy, mechanical energy, etc. to electrical energy. Generally, the power source 315 in the mobile device 300 may be a battery, such as a lithium battery, a nickel-metal hydride battery, or the like, that is used for powering various circuits, e.g., the transceiver circuit, and other devices that are used to operate the mobile device 300. Alternatively, the power source 315 may be a power adapter that can connect a power supply from a power outlet to the mobile device 300. In such embodiments, a power adapter may be classified as a power source “in” the mobile device.

The mobile device 300 may also include the memory 320 operatively coupled to the processor 310. As used herein, memory may include any computer readable medium configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory may additionally or alternatively include an electrically erasable programmable read-only memory (EEPROM), flash memory or the like.

The memory 320 may store any of a number of applications or programs which comprise computer-executable instructions/code executed by the processor 310 to implement the functions of the mobile device 300 described herein. For example, the memory 320 may include such applications as a social media offer application 321, a web browser application 322, an SMS application, an email application 324, etc.

FIG. 4 provides a block diagram illustrating the social media offer system 400 in greater detail, in accordance with embodiments of the invention. As illustrated in FIG. 4, in one embodiment of the invention, the social media offer system 400 includes a processing device 420 operatively coupled to a network communication interface 410 and a memory device 450.

It should be understood that the memory device 450 may include one or more databases or other data structures/repositories. The memory device 450 also includes computer-executable program code that instructs the processing device 420 to operate the network communication interface 410 to perform certain communication functions of the social media offer system 400 described herein. For example, in one embodiment of the social media offer system 400, the memory device 450 includes, but is not limited to, a network server application 470, a social media offer data storage 371, which includes user data storage 484, a social media offer application 321, which includes a mobile device interface 492, and other computer-executable instructions or other data. The computer-executable program code of the network server application 470 or the social media offer application 321 may instruct the processing device 420 to perform certain logic, data-processing, and data-storing functions of the social media offer system 400 described herein, as well as communication functions of the social media offer system 400, such as communication with a mobile device and/or a wireless server.

In some embodiments, the social media offer application 321 is the same application as located on the mobile device. In other embodiments, some functionality is present in the social media offer system 400 and some functionality is present in the mobile device. As should be understood, the software and hardware providing the social media offer functionality can be entirely present on the mobile device, entirely present on the social media offer system 400, or divided in some manner between the mobile device and the social media offer system 400. In further embodiments, the social media offer system also contributes to the social media offer functionality by augmenting data and/or processing power of the social media offer application(s) 321.

In further embodiments, the mobile device interface 492 facilitates communication between the mobile device and the social media offer system 400. For example, the mobile device interface 492 may establish a connection with the mobile device, may encrypt or decrypt communications with the mobile device, or may provide a portal for the user to interact with the social media offer application 321 through the mobile device.

As used herein, a “communication interface” generally includes a modem, server, transceiver, and/or other device for communicating with other devices on a network, and/or a user interface for communicating with one or more users. Referring again to FIG. 4, the network communication interface 410 is a communication interface having one or more communication devices configured to communicate with one or more other devices on the network 250, such as the mobile device 300, the social media offer system 400, and remote servers. The processing device 420 is configured to use the network communication interface 410 to transmit and/or receive data and/or commands to and/or from the other devices connected to the network 250.

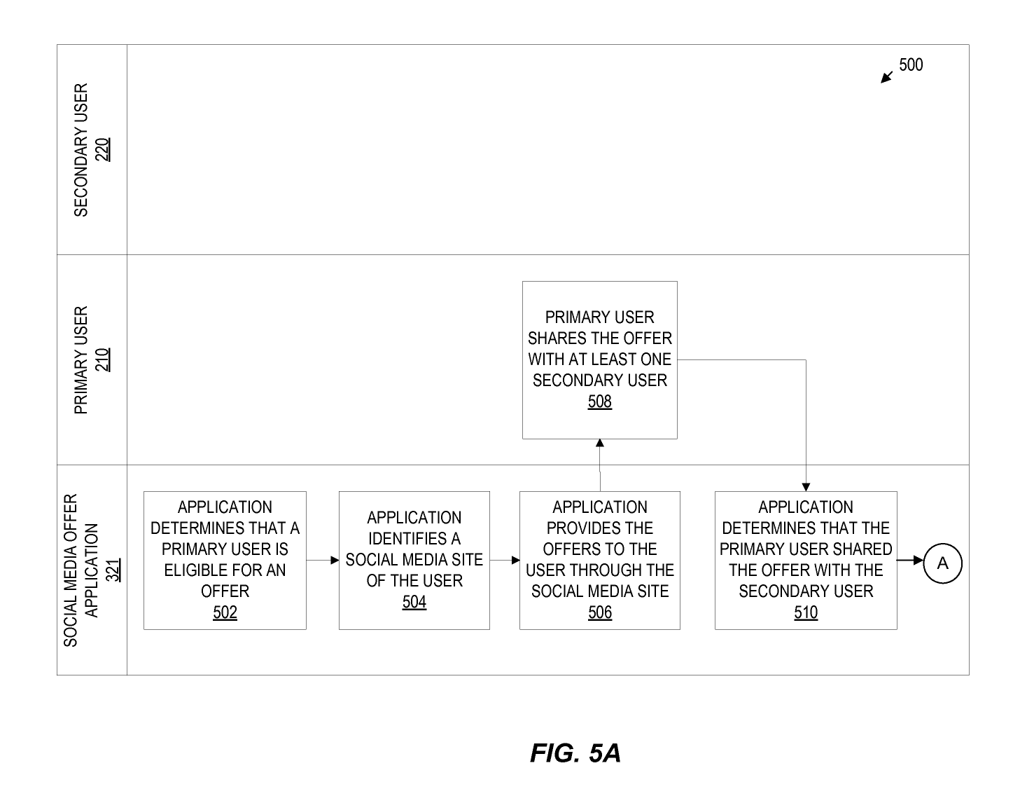

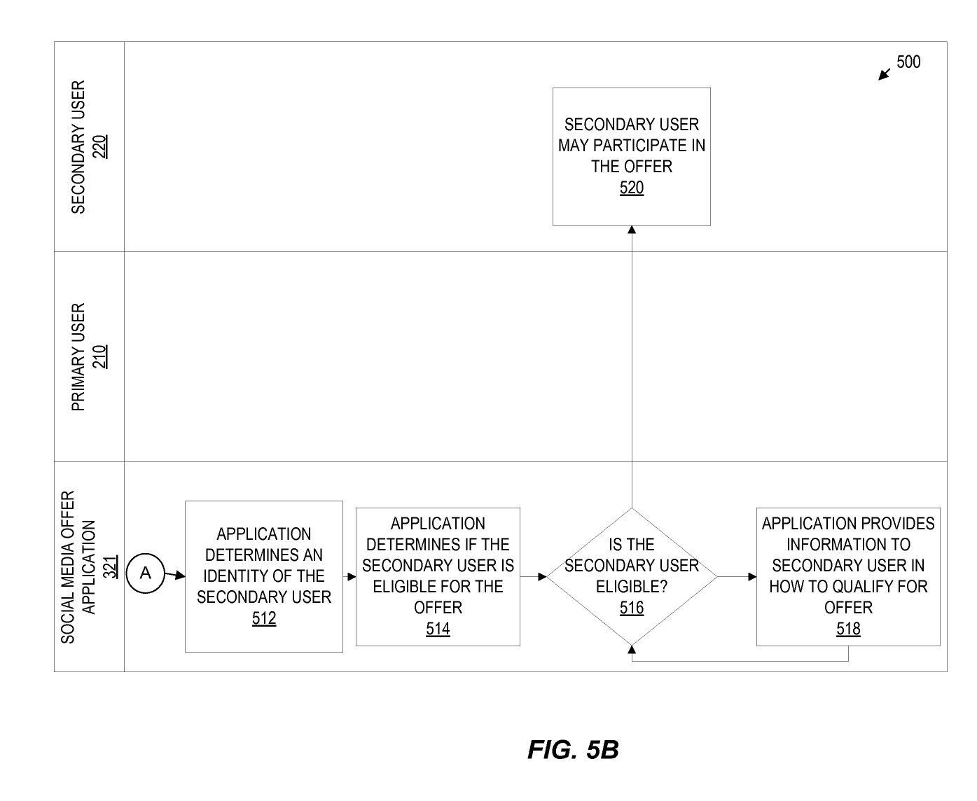

FIG. 5 is a process flow 500 illustrating a process flow for implementing a social media offer system, in accordance with embodiments of the invention. FIG. 5 depicts some of the process by which an offer is provided to a primary user, the primary user shares the offer with at least one secondary user, and the system determines whether the secondary user is eligible for the offer. In an embodiment, the social media offer system provides information to the user when the user is not eligible for the offer, such as instructions in how to qualify for the offer. It should be understood that the offers and actions described herein are examples and that one skilled in the art could envision other possibilities for use of the social media offer system as described herein.

Turning now to block 502, in some embodiments the application determines that a primary user is eligible for an offer. As discussed, the application may determine that the primary user is eligible for an offer based on an activity or characteristic of the primary user. For example, the system may determine that the primary user made a purchase at a merchant, bought a specific type of product, or has a minimum balance in an account. The activity may be related to the primary user's financial account, the primary user's social media account, or some other activity of the user. Activities related to social media accounts include connecting with a person or entity, liking an entity, becoming a fan of an entity, sharing a post, joining a group, etc. Characteristics of the primary user may relate to the current status of the user, such as the user's current location, the number of connections the user has, or the user's current status update on the social media site. In an embodiment, a marketing department of the financial institution determines which individuals are eligible for an offer and provide that information, such as via a database, to the application.

In block 504, in some embodiments the application identifies a social media site of the user. In an embodiment, the user provided the information relating to the user's social media sites to the application, such as by registering the social media sites with the application. By registering the social media sites with the application, the user is facilitating receiving offers from the application through the social media sites. In an embodiment, the user provides a hierarchy of social media sites to the application to provide guidance in how offers are provided to the user. For example, the user may specify that business-oriented social media sites receive offers related to professional services and products whereas personal-oriented social media sites receive offers related to personal shopping or products. In another embodiment, social media sites are categorized based on content present in the social media site. For example, if a social media site of a user includes subject matter relating to a specific business, e.g., the user likes the business, becomes a fan of the business, or otherwise highlights the business, the user may receive offers related to that business on that social media site rather than on another social media site of the user.

In block 506, the application provides the offers to the user through the social media site. The application may provide the offer to the user through public or private means. In one embodiment, the application provides the offer to the user through a private message, such as an instant message, chat message, or inbox message. In another embodiment, the application provides the offer to the user publicly. For example, the application may post the offer on the user's wall or make the offer publicly available on the user's social media profile. The offer may also be provided to the user through text message, email, phone call, or mail. For example, a social media site may be operated through telecom networks and include communication via text message.

In block 508, the primary user shares the offer with at least one secondary user. In some embodiments, the offer includes an opportunity for sharing the offer with other users. For example, the offer may provide a discount code as well as a share button. In an embodiment, the offer includes a predetermined sharing pattern, or hierarchy, defined by the system or the user and capable of sharing the offer in a specific manner upon request of the user. For example, the user may establish criteria or circles for sharing of offers. Specific groups, connections, or friends may automatically receive shared offers. Offers may also be categorized and different groups may be established to receive different categories of offers. In one example, a user joins or establishes an interest group, such as a sports fan group, and creates rules relating to offers relative to that interest group. The user may establish a rule that causes all offers categorized as sporting goods or sporting event to be shared with members of the interest group. The offers may be shared automatically upon the user receiving them or may only be shared when the user requests to share the offer. The provider of the social media offer system may provide default categories for offers or may categorize offers based on feedback from users.

In block 510, the application determines that the user shared the offer with at least one secondary user. As discussed, in one embodiment, the offer may have a tracking code, cookie, or application that tracks the offer's movement after being provided to the primary user. For example, the offer may send a message to the system when the offer is opened in a new social media site or by a new user (e.g., detecting a new IP address, MAC address, etc.). The offer may require that the secondary user log-in to take advantage of the offer, or attempt to take advantage of the offer, thereby alerting the application that the offer has been shared. In a further embodiment, the application determines that the offer has been shared based on the method of sharing. For example, the offer may provide a link or space to share the offer with other members of the social network or with social networks/media sites. Thus, the application itself shares the offer based on instructions received from the user and is able to determine that the user shared the offer with the secondary user in that way.

In block 512, in some embodiments the application determines an identity of the secondary user. In one embodiment, the application determines the identity of the secondary user from the social media site. For example, the social media site may include records relating to identities of users. In some embodiments, the identity of the secondary user is determined based on a connection between the secondary user and the provider of the social media offer system, for example, a connection between a financial institution and the social media site. In an embodiment, the application determines the identity of the user based on the information received when the application determines that the primary user shared the offer. For example, a cookie may transfer both the information that the offer was shared and identifying information for the secondary user to the system. The identifying information may be the secondary user's name, contact information, or IP address. In another embodiment, the secondary user is identified in coordination with account information related to the financial accounts. For example, the email address of the secondary user may be determined and compared to email addresses stored in a financial institution database. In a still further embodiment, the secondary user provides identification information to the system when logging in to access the offer.

It should be understood that is some embodiments, the complete identity of the secondary user is not necessary. For example, an offer may require that a secondary user be a fan of a specific business to qualify for the offer. If the application is able to determine that the secondary user is a fan of the business, then the complete identity of the secondary user is not necessary because the secondary user will still be eligible for the offer.

In some embodiments (not shown), the secondary user is prompted to authenticate the secondary user's identity. For example, in some embodiments, the provider of the social media offer system may prompt the secondary user to log-in to the secondary user's account at the social media site or at a financial institution. The secondary user may need to provide information relating to the primary user, such as the name of the primary user, a passcode provided to the primary user, etc. The secondary user may further be required to respond to a challenge question to indicate that the secondary user is not automatically receiving offers, i.e., that the secondary user is not a computer application that skims offers.

In block 514, the application determines whether the secondary user is eligible for the offer. Offers may require specific characteristics in a user. For example, the offer may require that a recipient have shopped at a specific merchant previously or spent a certain amount of money at the merchant previously. The offer may require that the secondary user be a fan of a merchant or financial institution. The offer may require that the secondary user be a customer of a financial institution, have a certain type of account with the financial institution, or maintain a predetermined balance in an account with the financial institution. As should be understood, criteria to determine who is eligible for an offer may be as varied as the offers themselves. The aforementioned examples are not intended to be limiting to the types of criteria, but rather to illustrate examples of criteria associated with offers.

In an exemplary embodiment, the offer may require that a secondary user be a member of a group or circle associated with the primary user. For example, the primary user may establish interest groups or social groups on the social media site which qualify members of the groups to receive specific offers. As an example, a user may establish a coworkers group, classify connections as being part of that group, and define the types of offers that are to be shared with that group (e.g., professional development opportunities, etc.). Users (primary and secondary) may establish their own groups, join groups established by others, or join groups defined by a financial institution or social media site.

In decision block 516, if the secondary user is eligible then the secondary user may participate in the offer, as depicted in block 520. If the secondary user is not eligible, then the application provides information to the secondary user in how to qualify for the offer, as depicted in block 518.

Turning now to block 518, if the user is not eligible then the application provides information to the secondary user in how to qualify for the offer. In an embodiment, the application provides the criteria for receiving the offer to the user. For example, the offer may require that the user perform an action on the social media site, such as liking a business, connecting to an entity, or having a minimum number of friends. The instructions may be provided to the user through the social media site, through an email, text message, or other communication means. In an embodiment, the application facilitates the action needed by the secondary user to become eligible for the offer. For example, the application may inform that user that the user is not eligible because the user does not have a specific type of account at a financial institution. At the same time, however, the application may offer to enroll the user in the required type of account so that the user is eligible for the offer.

Finally, in block 520, in some embodiments when the secondary user is eligible for the offer the secondary user may participate in the offer. The secondary user may automatically take advantage of the offer or may have to log-in to take advantage of the offer. In some embodiments, the user may delay taking advantage of the offer by saving the offer while in other embodiments the user must use the offer immediately.

It should be understood that the application creates a viral sharing of offers through social networks based on social media sites and qualified users. The distinction between a primary user and a secondary user is for convenience only to identify the initial recipient and the later recipient of an offer. Secondary users may also share offers with connections in their social network, thereby becoming “primary users” and proceeding through the determination, identification, and providing steps disclosed herein.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

We claim:

1. A social media offer system for assisting users in becoming eligible for offers, the system comprising:
a memory device;
a communication device; and
a processing device, operatively coupled to the memory device and the communication device, and configured to execute computer-readable program code to:
determine, via a computing device processor, that a primary user shared an offer with a secondary user;
determine, via a computing device processor, an identity of the secondary user;
determine whether the secondary user is eligible for the offer based on the identity of the secondary user; and
provide information to the secondary user when the secondary user is not eligible for the offer.

2. The system of claim 1, wherein the information comprises instructions on how to qualify for the offer.

3. The system of claim 1, further comprising assisting the secondary user in qualifying for the offer.

4. The system of claim 3, wherein the assisting comprises enrolling the secondary user in an account.

5. The system of claim 1, wherein the computer-readable program code is further configured to:
identify a social media site of the secondary user;
evaluate whether the secondary user is eligible for the offer based on the social media site; and
offer to alter a profile of the secondary user on the social media site when the secondary user is not eligible for the offer, such that altering the profile makes the secondary user eligible for the offer.

6. The system of claim 1, wherein the primary user shares the offer with the secondary user based on a group defined by the primary user.

7. The system of claim 6, wherein the identity of the secondary user is determined based on a cookie associated with the offer, wherein the cookie reports the identity of the secondary user to the system when the secondary user accesses the offer.

8. A social media offer computer program product for assisting users in becoming eligible for offers, the computer program product comprising at least one non-transitory computer-readable medium having computer-readable program code portions embodied therein, the computer-readable program code portions comprising:
an executable portion configured for determining that a primary user shared an offer with a secondary user;
an executable portion configured for determining an identity of the secondary user;
an executable portion configured for determining whether the secondary user is eligible for the offer based on the identity of the secondary user; and
an executable portion configured for providing information to the secondary user when the secondary user is not eligible for the offer.

9. The computer program product of claim 8, wherein the information comprises instructions on how to qualify for the offer.

10. The computer program product of claim 8, further comprising assisting the secondary user in qualifying for the offer.

11. The computer program product of claim 10, wherein the assisting comprises enrolling the secondary user in an account.

12. The computer program product of claim 8, further comprising an executable portion configured to:
identify a social media site of the secondary user;
evaluate whether the secondary user is eligible for the offer based on the social media site; and
offer to alter a profile of the secondary user on the social media site when the secondary user is not eligible for the offer, such that altering the profile makes the secondary user eligible for the offer.

13. The computer program product of claim 8, wherein the primary user shares the offer with the secondary user based on a group defined by the primary user.

14. A social media offer method for assisting users in becoming eligible for offers, the method comprising:
using a computer processor comprising computer program code instructions stored in a non-transitory computer readable medium, wherein said computer program code instructions are structured to cause said computer processor to:
determine, via a computing device processor, that a primary user shared an offer with a secondary user;
determine, via a computing device processor, an identity of the secondary user;
determine, via a computing device processor, whether the secondary user is eligible for the offer based on the identity of the secondary user; and
provide information to the secondary user when the secondary user is not eligible for the offer.

15. The method of claim 14, wherein the information comprises instructions on how to qualify for the offer.

16. The method of claim 14, further comprising assisting the secondary user in qualifying for the offer.

17. The method of claim 16, wherein the assisting comprises enrolling the secondary user in an account.

18. The method of claim 14, further comprising:
identifying a social media site of the secondary user;
evaluating whether the secondary user is eligible for the offer based on the social media site; and
offering to alter a profile of the secondary user on the social media site when the secondary user is not eligible for the offer, such that altering the profile makes the secondary user eligible for the offer.

19. The method of claim 18, wherein the primary user shares the offer with the secondary user based on a group defined by the primary user.

20. The method of claim 14, wherein the identity of the secondary user is determined based on a cookie associated with the offer, wherein the cookie reports the identity of the secondary user to the system when the secondary user accesses the offer.
